(19) United States
(12) Patent Application Publication
(10) Pub. No.: US 2014/0146534 A1
(43) Pub. Date: May 29, 2014

(54) LED LAMP

(71) Applicants: William Chiu, (US); Chin-Wen Wang, (US)

(72) Inventor: Chin-Wen WANG, Taoyuan County (TW)

(73) Assignees: Chin-Wen WANG, Taoyuan County (TW); William CHIU, Hong Kong (HK)

(21) Appl. No.: 13/684,256

(22) Filed: Nov. 23, 2012

(51) Int. Cl. F21V 29/00

(52) U.S. Cl. CPC F21V 29/20
USPC 362/249.02

(57) ABSTRACT

A light emitting diode (LED) lamp includes a holding assembly, at least one LED and a heat pipe. The holding assembly includes a thermal-conductive base and at least one fixing component connected to the thermal-conductive base. The LED is mounted on one side of the thermal-conductive base. The heat pipe is inserted in the fixing component, such that a passageway is formed and communicating with an inside of the heat pipe. As this result, a plurality of airflow passages are formed on the thermal-conductive base, and the LED lamp can achieve good thermal-conductive efficiency.

### BACKGROUND OF THE INVENTION

1. Field of the Invention

The present invention relates to a lighting apparatus, and in particular to a light emitting diode (LED) lamp.

2. Description of Related Art

Light emitting diode (LED) has advantages of high brightness, lower power consumption, and long life time, and becomes popular in multiple fields. While power of lighting module constructed by LEDs increases, LED is applied to various lighting apparatus, and becomes mainly light source corresponded to energy conservation and environmental protection.

Therefore, applicability of the LED is becoming more and more wildly. For example, a conventional street lamp usually uses incandescent bulbs or mercury lamps as luminous body. However, incandescent bulbs or mercury lamps is replaced by LEDs nowadays, which achieves the effect of energy conservation.

However, when the power and brightness of LEDs gradually increase, heat generated by the LEDs is also higher than small-power or low-brightness LEDs. While the heat cannot be effectively dissipated, it will affect lighting quality of the LEDs, even damage the LEDs, and shorten the lifetime of the LEDs. Therefore, a designation of LEDs with good thermal conduction can not only increase light quality, but lengthen lifetime of the LEDs.

### SUMMARY OF THE INVENTION

It is an object to provide a light emitting diode (LED) lamp, which is communicating an inside of a heat pipe and a passageway, and forming a plurality of airflow passageways on a thermal-conductive base to achieve good thermal-conductive efficiency.

Accordingly, the LED lamp comprises a holding assembly, at least one LED and a heat pipe. The holding assembly comprises a thermal-conductive base and at least one fixing component. The LED is mounted on one side of the thermal-conductive base. The heat pipe is inserted in the fixing component communicating with an inside of the heat pipe.

The inside of the heat pipe is communicating with the passageway, such that an airflow passage is formed on the thermal-conductive base, and convection is formed by blowing cold gas into the airflow passage for conducting heat generated by the LED out of the thermal-conductive base and the heat pipe. Therefore, the LED lamp of the present invention has good heat-dissipating efficient.

In addition, the fixing component comprises a plurality of coupling blocks extending from the thermal-conductive base and arranged in interval, each coupling block comprises an engaging parts for engaging with buckling sections formed within the heat pipe. Two protruding strips are extending from an inner wall of the heat pipe, wherein the buckling sections are formed by bending the two protruding strips by stamping. Therefore, the connective stability of the heat pipe and the fixing component is increased.

Moreover, a through hole is disposed on the thermal-conductive base and opposite to the coupling block. The through hole is also corresponded to an inside of the heat pipe. As the result, an airflow passage is formed by the inside of the heat pipe and the passage, and another airflow passage is formed by the inside of the heat pipe and the through hole for enhancing heat-dissipating effect of the LED lamp.

Furthermore, when the LED lamp is used in pool weather, rainwater can flow into the het pipe, and then discharge by the passageway or the through hole, thus achieving an effect of cleaning the heat pipe and maintaining heat-dissipating effect of the heat pipe.

Besides, a plurality of fins are connected to an outer circumference of the heat pipe for enhancing heat-dissipating effect of the heat pipe.

### BRIEF DESCRIPTION OF DRAWING

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 is an assemble view of an LED lamp according to a first embodiment of the present invention.

FIG. 2 is a perspective view of a thermal-conductive base and a heat pipe according to the first embodiment of the present invention.

FIG. 3 is a schematic view showing that heat pipe covers engaging part according to the first embodiment of the present invention.

FIG. 4 is a schematic view showing that protruding strips are formed to buckling sections according to the first embodiment of the present invention.

FIG. 5 is an assemble view of thermal-conductive base and heat pipe according to the first embodiment of the present invention.

FIG. 6 is an assembly sectional view of thermal-conductive base and heat pipe according to the first embodiment of the present invention.

FIG. 7 is another assembly sectional view of thermal-conductive base and heat pipe according to the first embodiment of the present invention.

FIG. 8 is an assembly sectional view of the LED lamp according to a second embodiment of the present invention.

FIG. 9 is a section view of a heat pipe according to a second embodiment of the present invention.

FIG. 10 is an assembly sectional view of a thermal-conductive base and heat pipe according to a third embodiment of the present invention.

FIG. 11 is another assembly sectional of the thermal-conductive base and heat-pipe according to the present invention.

FIG. 12 is a sectional view of the heat pipe according to the third embodiment of the present invention.

### DETAILED DESCRIPTION OF THE INVENTION

A preferred embodiment of the present invention will be described with reference to the drawings.

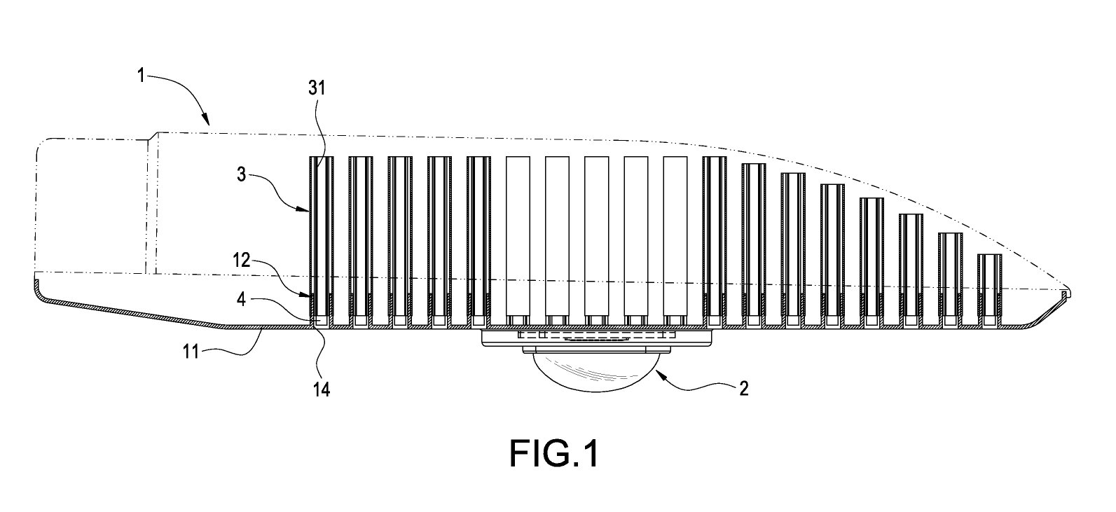

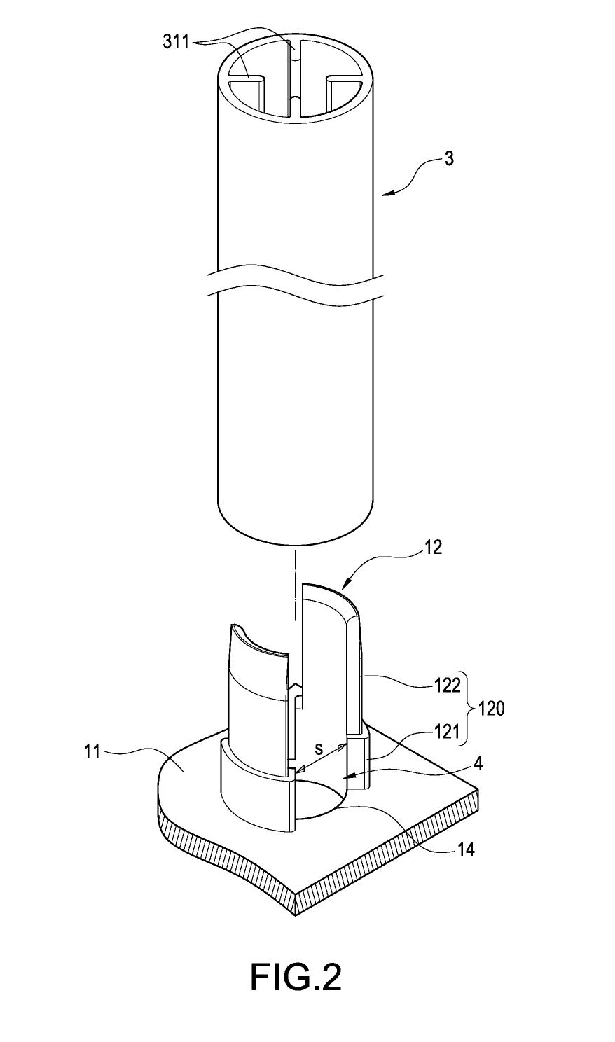

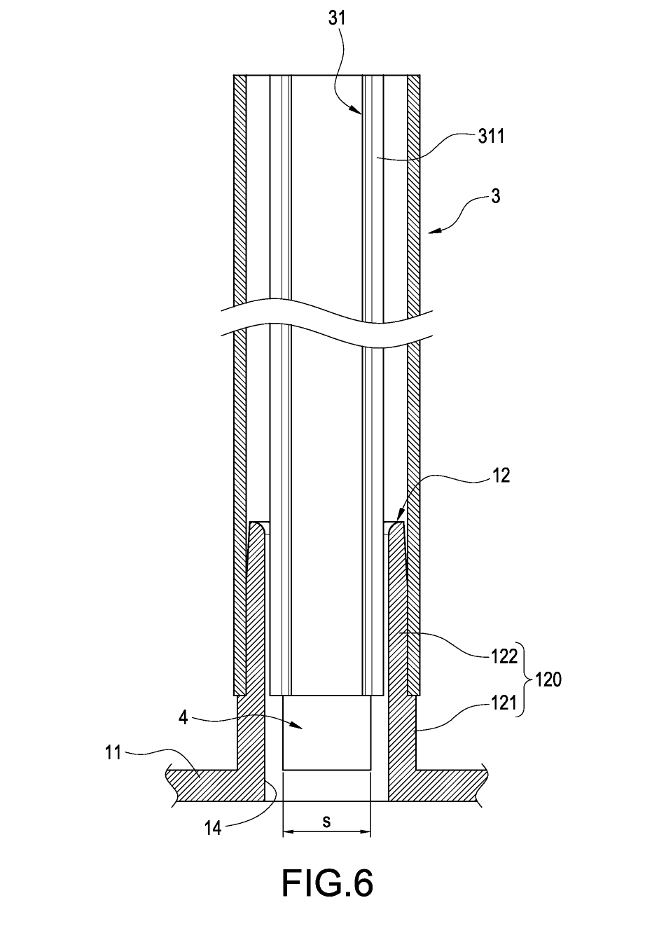

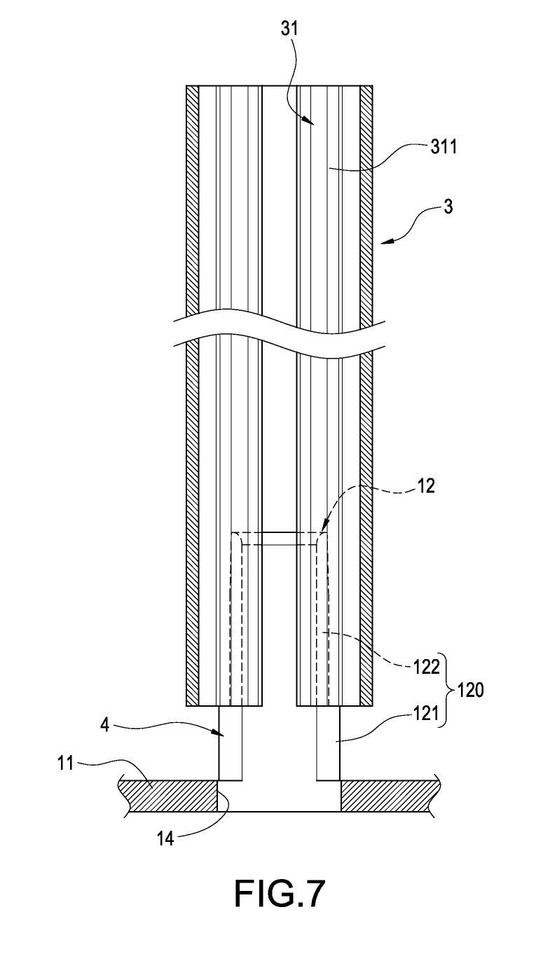

Referring to FIG. 1 to FIG. 7, which show a light emitting diode (LED) lamp according to a first embodiment of the present invention. The LED lamp includes a holding assembly 1, at least one LED 2 and at least one heat pipe 3.

The holding assembly 1 includes a heat-conductive base 11 and at least one fixing component 12 connected to the thermal-conductive base 11. In this embodiment, the holding assembly 1 includes, for example, multiple fixing components 11. The thermal-conductive base 11 is made of copper, aluminum or other material with good thermal conductivity. Each fixing component 12 includes at least two coupling blocks 120 extending from the thermal-conductive base 11 and arranged in intervals. An interval s is between each two adjacent coupling blocks 120. Each coupling block 120 has a raised part 121 and an engaging part 122 extending from a direction which is far away from where the hear-conductive base 11 is disposed. An interval s is between each two adjacent raised part 121. A through hole is disposed on the thermal-conductive base 11 and opposite to where the coupling block 120 is disposed.

The LED 2 is mounted on one side of the thermal-conductive base 11.

The heat pipe 3 is made of aluminum, copper or other material with good thermal conductivity, and the amount of the hear pipes 3 is the same as the amount of the fixing components 3. Each heat pipe 3 is inserted in each fixing component 12, such that a passageway 4 is formed and communicated with an inside of each heat pipe 3. In more particularly, each heat pipes 3 is engaged with the coupling blocks 120 and covers the engaging parts 122, such that each heat pipe 3 is fixed on the raised parts 121. The interval s between each two adjacent coupling blocks 120 is formed the passageway 4 and communicating with the heat pipe 3. In addition, an outer circumference of each engaging part 122 is engaged with an inner circumference of each heat pipe 3. A plurality of buckling sections 31 are formed within the heat pipe 3, and the amount of the buckling sections 31 is the same as the amount of the engaging parts 12 for engaging with the engaging parts 122, respectively. In particularly, the buckling parts 122 are formed by extending two protruding strips 311 on an inner wall of the heat pipe 3 at first, and then bending the protruding strips 311 by stamping.

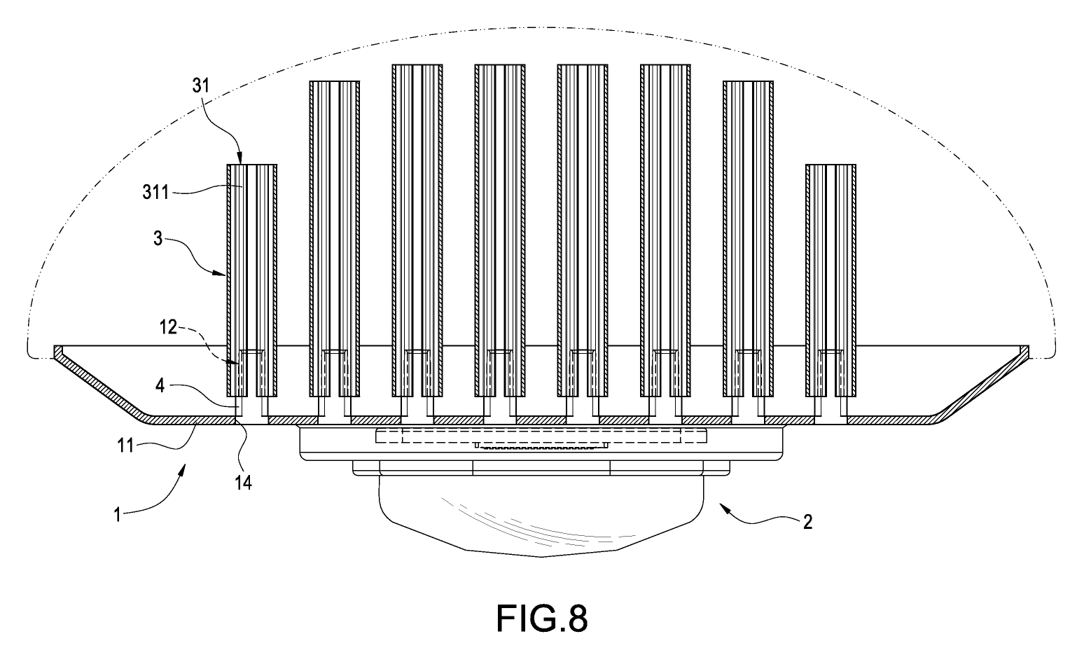

Referring to FIG. 8, FIG. 8 is an assemble view of the LED lamp according to the first embodiment of the present invention. The holding assembly 1 includes a thermal-conductive base 11 and a plurality of fixing components 12 connected to the thermal-conductive base 11. The LED 2 is mounted on one side of the thermal-conductive base 11. The heat pipes 3 are respectively inserted in the fixing components 12, such that the passageways 4 are formed and communicating with the heat pipes 3. As the result, the inside of each heat pipes 3 is communicating with the passageway 4, and an airflow-passageway is formed on the thermal-conductive base 4. A convection guiding heat generated by the LED 2 away from the thermal-conductive base 11 and the pipes 3 is achieved by blowing a cold gas into the airflow passage, and then the LED lamp of the present invention can have good thermal-conductive efficiency.

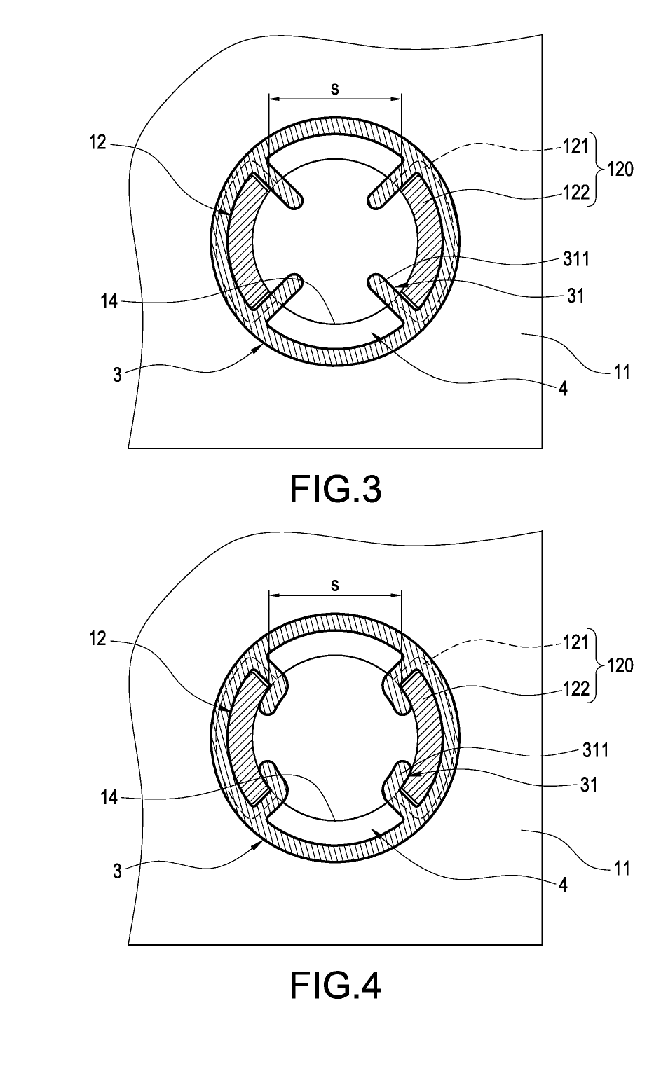

Referring again to FIG. 3 and FIG. 4, FIG. 3 and FIG. 4 are assembly sectional views of the heat pipe and fixing component according to the present invention. Each fixing component 12 includes the coupling blocks 120 extending from the thermal-conductive base 11 and arranged in interval. Each coupling block 120 has a plurality of engaging parts 122. Each heat pipe 3 has a plurality of buckling sections 31 engaged with the engaging parts 122. The buckling sections 31 are formed by extending two protruding strips 311 from the inner wall of the heat pipe 3 and bent the protruding strips 311 by stamping, which can increase connective stability of the heat pipe 3 and the fixing component 12.

In addition, each heat pipe 3 is a circular pipe, and each engaging parts 122, for example, is of meniscus shape. However, in the practical application, the profile of each heat pipe 3 and each engaging part 122 may be adjusted by demand.

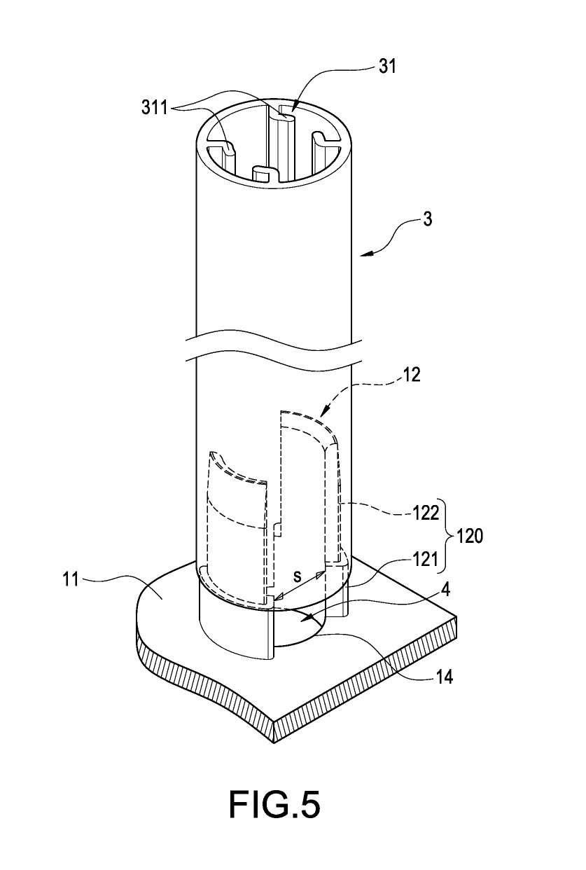

With referring again to FIG. 5 to FIG. 7, the through hole 14 is disposed on the thermal-conductive base 11 and opposite to where the coupling block 120 is disposed. The through hole is also corresponded to the inside of the heat pipe 3, such that a flow passageway is defined by the inside of the heat pipe 3 and the passageway 4, and another flow passageway is defined by the inside of the heat pipe 3 and the through hole 14, which can increase heat-dissipating efficiency of the LED lamp of the present invention.

Besides, when the LED lamp is used in street light or outdoor application, it is difficult to prevent dust from attaching the heat pipe 3, which will decrease the heat-dissipated efficiency of the heat pipe 3. However, the LED lamp of the present invention let rainwater flow through the heat pipe 3, and then discharges the rainwater via the passageway 4 or the through hole 14, thus achieving the effect of cleaning the heat pipe 3 and maintaining heat-dissipating efficiency of the heat pipe 3.

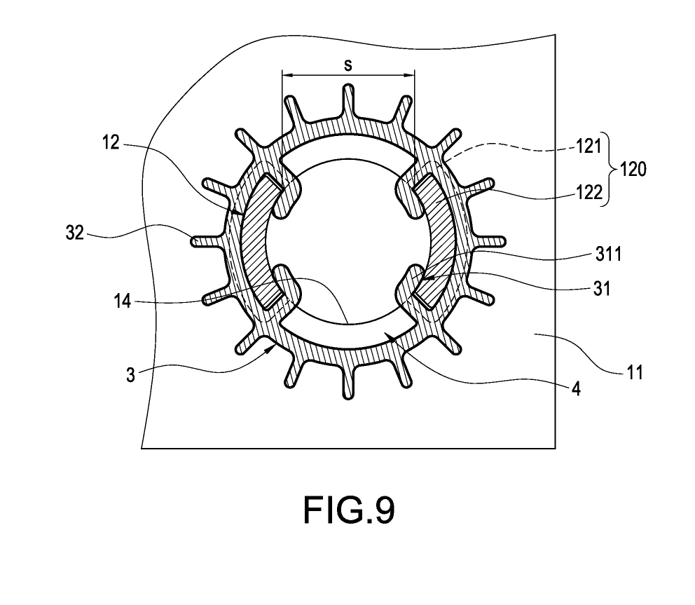

Referring to FIG. 9, FIG. 9 is a section view of a heat pipe according to a second embodiment of the present invention. A plurality of fins 32 are connected to an outer circumference of the heat pipe 3 for increasing heat-dissipating efficiency of the heat pipe 3.

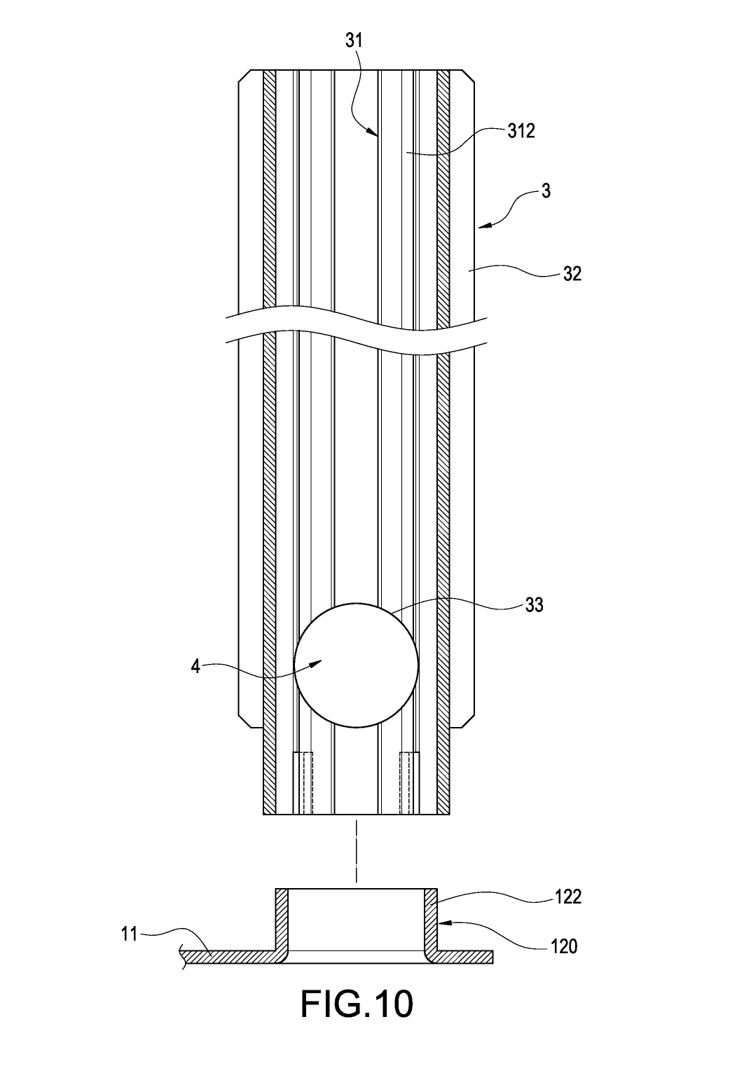

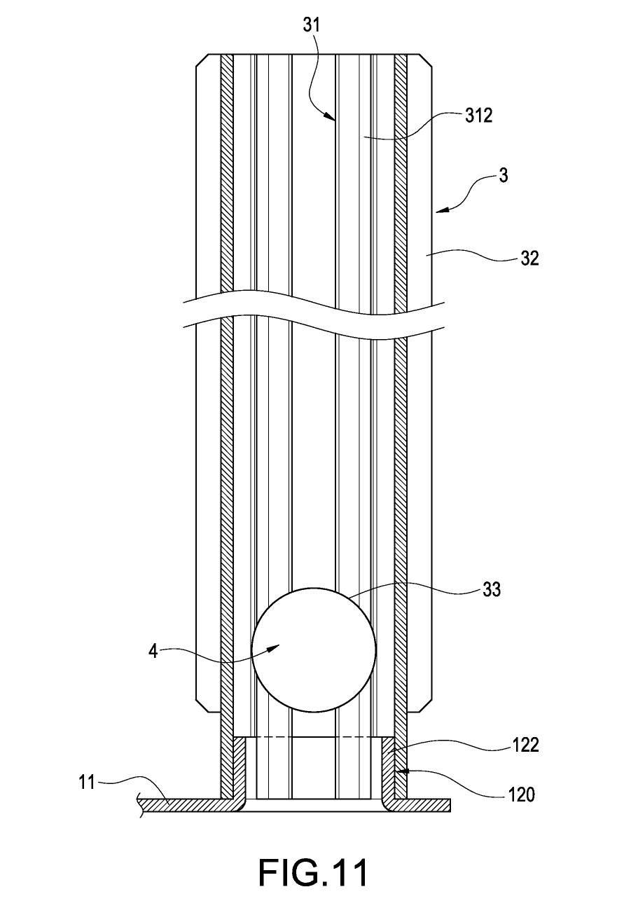

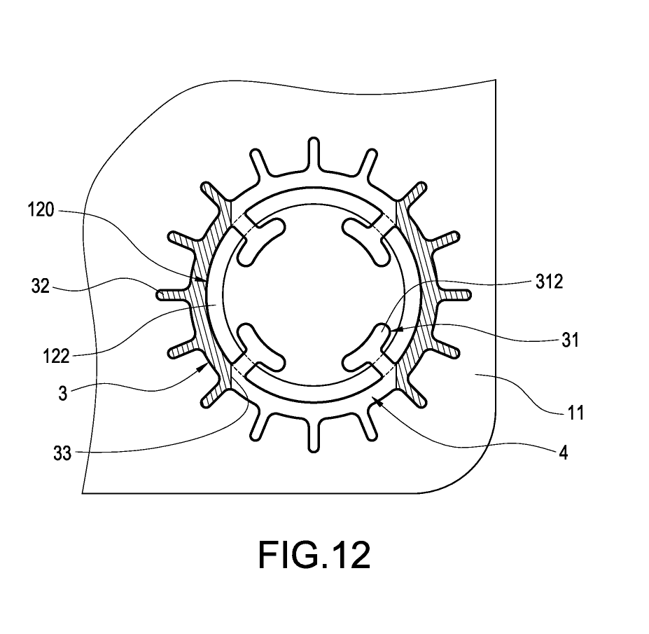

Referring to FIG. 10 to FIG. 12, FIG. 10 is an assembly sectional view of a thermal-conductive base and heat pipe according to a third embodiment of the present invention, FIG. 11 is another assembly sectional of the thermal-conductive base and heat-pipe according to the third embodiment of the present invention, and FIG. 12 is a sectional view of the heat pipe according to the third embodiment of the present invention. A passageway 4 is disposed on the heat pipe 3. In more particularly, at least one opening 33 is disposed on an outer circumference of the heat pipe 3, the distance between the opening 33 and the thermal-conductive base 11 is larger than the height of the coupling block 120 for preventing the opening 33 from blocking by the coupling block 120. The opening 33 is used for forming a passageway 4. As the result, an inside of the heat pipe 3 is communicated with the passageway 4, and an airflow passageway is formed on the thermal-conductive base 11 for convection, which can assist in conducting heat generated by LED 2.

Besides, the combination of each heat pipe 3 and each fixing component 12 is described as below. Each fixing component 12 has a coupling block 120 extending from the thermal-conductive base 11. The coupling block 120 is an annulus block. In addition, an engaging part 122 is extending from a direction which is opposite to where the thermal-conductive base 11 is disposed. The engaging part 122 is also an annulus block. Furthermore, at least one L-shaped block 312 is formed on an inner wall of the heat pipe 11. The amount of the L-shaped block 312 is, for example, four. A buckling section 31 is formed on the L-shaped block 312, and at least one space is collectively defined by the buckling section 31 and the heat pipe 3. The engaging part 122 penetrates through and is confined in the space for stably connecting the heat pipe 3 and fixing component 12.

Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A light emitting diode (LED) lamp comprising:
a holding assembly comprising a thermal-conductive base and at least one fixing component connected to the thermal-conductive base;
at least one LED mounted on one side of the thermal-conductive base; and
at least one heat pipe inserted in the fixing component and forming a passageway communicating with an inside of the heat pipe.

2. The LED lamp in claim 1, wherein the fixing component includes at least two coupling blocks extending form the thermal-conductive base and arranged in interval, and an interval is formed between each two coupling block for forming the passageway, the heat pipe is inserted in the coupling blocks.

3. The LED lamp in claim 2, wherein each coupling block comprises a raised part and an engaging part, the engaging part is extending from the raised part and toward a direction away from the thermal-conductive base, the heat pipe covers the engaging parts of the coupling blocks, and the interval is formed between each two adjacent raised parts.

4. The LED lamp in claim 2, wherein each coupling block comprises a plurality of engaging parts extending from a direction away from the thermal-conductive base, the heat pipe comprises a plurality of buckling sections for respectively engaging with the engaging parts, wherein an amount of the buckling sections is the same as an amount of the engaging part.

5. The LED lamp in claim 4, wherein two protruding strips are extending from an inner wall of the heat pipe, wherein the buckling sections are formed by bending the two protruding strips respectively by stamping.

6. The LED lamp in claim 4, wherein at least one L-shaped block is formed on an inner wall of the heat pipe, a buckling section is formed on the L-shaped block, and at least one space is collectively define by the buckling section and the heat pipe, each engaging part penetrating through and confined in the space.

7. The LED lamp in claim 4, wherein an outer circumference of the engaging part is engaged with an inner circumference of the heat pipe.

8. The LED lamp in claim 7, wherein the heat pipe is a circular pipe, the engaging parts are respectively of meniscus shape.

9. The LED lamp in claim 2, wherein a through hole is disposed on the thermal-conductive base and corresponded to the coupling block.

10. The LED lamp in claim 1, wherein the fixing component comprises a coupling block extending from the thermal-conductive base, and the heat pipe is engaged with the coupling block, an outer circumference of the heat pipe has at least one opening for forming the passageway.

11. The LED lamp in claim 10, wherein the coupling block comprises plurality of engaging parts extending from a direction away from the thermal-conductive base, the heat pipe comprises a plurality of buckling sections, the buckling sections are respectively engaged with the engaging parts, wherein an amount of the buckling sections is the same as an amount of the engaging parts.

12. The LED lamp in claim 11, wherein two protruding strips are extending from an inner wall of the heat pipe, the buckling sections are formed by bending the two protruding strips by stamping.

13. The LED lamp in claim 11, wherein an inner wall of the heat pipe comprises at least one L-shaped block extending toward the thermal-conductive base, the L-shaped block and the heat pipe collectively defined the buckling section, a space is between the L-shaped block and the heat pipe, the engaging part penetrates through and is confined in the space.

14. The LED lamp in claim 11, wherein the outer circumference of the engaging part is engaged with the inner circumference of the heat pipe.

15. The LED lamp in claim 14, wherein the heat pipe is a circular pipe, and engaging parts are respectively of meniscus shape.

16. The LED lamp in claim 10, wherein a through hole is disposed on the thermal-conductive base and corresponded to the coupling block.

17. The LED lamp in claim 1, wherein a plurality of fins are connected to an outer circumference of the heat pipe.
